(19) United States
(12) Patent Application Publication
(10) Pub. No.: US 2019/0002310 A1
(43) Pub. Date: Jan. 3, 2019

(54) OCEAN THERMOCLINE DRIVEN MEMBRANE DISTILLATION PROCESS

(71) Applicant: KING ABDULLAH UNIVERSITY OF SCIENCE AND TECHNOLOGY, Thuwal (SA)

(72) Inventors: Lijo FRANCIS, Thuwal (SA); Noreddine GHAFFOUR, Thuwal (SA); Ahmad S. ALSAADI, Thuwal (SA); Raju ABRAHAM, Thuwal (SA)

(21) Appl. No.: 16/068,010

(22) PCT Filed: Jan. 13, 2017
(86) PCT No.: PCT/IB2017/050203

§ 371 Date: Jul. 3, 2018

Related U.S. Application Data
(60) Provisional application No. 62/278,639, filed on Jan. 14, 2016.

(51) Int. Cl. C02F 1/44; B01D 61/36

(52) U.S. Cl. CPC C02F 1/447; C02F 2103/08; B01D 61/364

(57) ABSTRACT

Systems and methods using membrane distillation are provided for desalinating water, for example for the production of potable water, to address freshwater requirements. In an aspect the systems and methods do not require applying an external heat source, or the energy cost of the heating source, to heat the feed stream to the membrane. In an aspect, the sensible heat present in surface seawater is used for the heat energy for the warm stream fed to the membrane, and deep seawater is used as the cold/coolant feed to the membrane to provide the needed temperature gradient or differential across the membrane.

### CROSS-REFERENCE TO RELATED APPLICATIONS

This application claims the benefit of and priority to U.S. Provisional Application Ser. No. 62/278,639, having the title “OCEAN THERMOCLINE DRIVEN MEMBRANE DISTILLATION PROCESS,” filed on Jan. 14, 2016, the disclosure of which is incorporated herein in by reference in its entirety.

### TECHNICAL FIELD

The present disclosure generally relates to desalination of seawater, in particular use of membrane distillation for desalination of seawater.

### BACKGROUND

Technical advances in desalination over the last thirty years have resulted in significant reductions in energy consumption and correspondingly, overall desalination cost.^{[1,2]} Now desalination is considered a feasible technology to mitigate the shortage of portable water all over the world.

The cost of existing technologies is still an obstacle, however. Substantially reducing the cost of desalination is highly desired, but unlikely from existing technologies since they are reaching their technical limits.^{[1]} An innovative technology coupled with inexpensive sustainable energy resources is desired to reduce desalination cost.

Membrane distillation (MD) is a thermally driven membrane-based separation process, considered as one of the technologies that are emerging for potential use in desalination processes. MD utilizes a hydrophobic, micro-porous membrane as a contactor to achieve separation by liquid-vapor equilibrium. Pre-heated feed solution is brought into contact with the membrane which allows only the water vapor to pass through the membrane pores where it condenses on the other side of the membrane. This vapor is driven across the membrane by the difference in the partial vapor pressure maintained at the two sides of the membrane created by a difference of temperatures (feed/coolant).

Conventional membrane distillation, however, involves providing a pre-heated feed stream to the membrane. The feed stream is heated by use of an external heat energy source at a cost. The heat energy source can be in the form of waste heat, or renewable heat sources such as solar energy. This can require providing at a cost solar collectors or any other means to harvest the external heat energy required to heat the feed stream.

There exists a vertical temperature gradient of generally 10 to 25° C. in the ocean due to the continuous absorption of solar energy by ocean surface. This gradient can be higher in tropical waters. This gradient is more or less constant during different seasons as water below more than 100 m depth is unmixed.

There are attempts to utilize the ocean temperature gradient for power generation as well as production of potable water. Low temperature flash evaporation of warm surface water under vacuum conditions followed by condensation of the vapor generated in a surface condenser can produce high quality distillate. There are some working pilot plants (e.g., Hawaiian Islands, United States, and Kawaratti Island, India) where the temperature gradient between surface seawater and deep seawater has been directly utilized to produce fresh water using low temperature flash distillation.¹³⁻²¹ A low pressure-ratio vapor turbine can be introduced between evaporator and condenser, if electric power is required. In spite of several attempts, these technologies could not be commercialized due to the large requirement of sea water flow rates, difficulty in handling large size equipment, higher investment costs, etc.

Earlier attempts to use ocean temperature difference for desalination based on flash distillation principle encountered many challenges to create and maintain low vacuum due the large size chambers used. Large quantity of sea water was required as the conversion ratio of distillate to seawater was very low. Hence the unit power consumption was high. Because of all these reasons, the technology was never commercialized.

Accordingly, there is a need to address the aforementioned deficiencies and inadequacies.

### SUMMARY

Freshwater requirements are alarmingly increasing in almost all parts of the globe. Water requirements may double by the year 2050 A D. Many parts of the world are already in water stress including Saudi Arabia. World water industry is growing at 20-30% in a year and many large water capacity plants in the range of 300-600 MLD are being installed. However, the cost of produced water is also increasing due to the increase in power, material, and labor costs and environmental regulations. There are strict environmental regulations imposed due to the large capacity desalination plants and the thermal, chemical, biological pollutions and ecological disturbance associated with seawater intake and brine disposal.

In the present disclosure systems and methods are provided for desalinating water, for example for the production of potable water, to address freshwater requirements. In an aspect our systems and methods do not require applying an external heat source, or the energy cost of the heating source, to heat the feed stream to the membrane as in the conventional MD process. Fresh water can be produced more efficiently than for example from low temperature flash distillation from the same source using a different technology called membrane distillation.

In an aspect, the sensible heat present in surface seawater can be used for the heat energy for the warm stream fed to the membrane, and deep seawater used as the cold/coolant feed to the membrane to provide the needed temperature gradient or differential across the membrane.

In an embodiment a method for membrane distillation of seawater for desalination of seawater is provided herein. The method can comprise the steps of:

a) providing a membrane distillation module including a housing, a warm fluid section, a cold fluid section, a permeate section, a membrane positioned between the warm fluid section and the permeate section, at least a portion of the membrane being adjacent to and in communication with at least a portion of the warm fluid section and a condensation surface positioned in association with the permeate section and the cold fluid section,
wherein the warm fluid section and the cold fluid section each include a fluid inlet through which fluid can be delivered into each of the warm fluid and cold fluid sections and a fluid outlet through which fluid can flow out of each of the warm fluid and cold fluid sections, and
wherein the permeate section includes an outlet through which permeate can flow out of the permeate section, and
wherein the membrane is comprised of a material that permits water vapor to pass there through but not water;

b) passing warm fluid through the warm fluid section, the warm fluid being warm seawater;

c) passing cold fluid through the cold fluid section, the cold fluid being seawater that is relatively colder than the warm fluid, thereby creating a temperature difference between the warm fluid and the cold fluid; and

d) passing permeate from the warm fluid section through the membrane into the permeate section, by utilizing a vapor pressure difference across the membrane due to the temperature difference between the warm fluid and the cold fluid streams, the permeate being in the form of water vapor.

In any one or more aspects of the method the warm fluid can have a temperature in the range of 23-35° C. The warm fluid can be taken directly from the sea or ocean from a depth of 5-8 meters below the surface of the sea or ocean without heating or cooling and utilizing its own sensible heat by passing the warm fluid into the warm fluid section of the membrane distillation module. The cold fluid can be in the form of cold seawater. The cold seawater can have a temperature in the range of 4-18° C. The cold seawater can be taken directly from the sea or ocean from a depth of 250-300 m below the surface of the sea or ocean. The cold seawater can be passed directly into the cold fluid section of the membrane distillation module without heating or cooling the cold seawater. In various aspects, the temperature of the warm fluid passed into the warm fluid section can be in the range of 23-30° C. The temperature of the warm fluid passed out of the warm fluid section can be in the range of 14-16° C. The temperature difference between the warm fluid passed into the warm fluid section and the cold fluid passed into of the cold fluid section can be in the range of 7-26° C. In various aspects, the temperature of the cold fluid passed into the cold fluid section can be in the range of 4-16° C. The temperature of the cold fluid passed out of the cold fluid section can be in the range of 24-26° C. The condensation surface can be in thermal association with the cold fluid and the method can include the step of passing the permeate in the permeate section into thermal contact with the condensation surface and condensing the permeate. The method can include applying a negative pressure to the permeate condensation section, for example by applying a vacuum to the permeate condensation section. The warm fluid can be obtained from surface seawater, hot water discharge from a water plant, from waste heat from a ship engine or any combination thereof.

In any one or more aspects of the method, the condensation surface can isolate cold fluid provided in the cold fluid section from permeate that may collect in the permeate section. The membrane distillation module can be selected from the group consisting of an air gap membrane distillation (AGMD) module, a vacuum enhanced air gap membrane distillation (VAGMD) module, a vacuum membrane distillation (VMD) module and/or a sweeping gas membrane distillation (SGMD) module. The permeate section can be positioned between the warm fluid and cold fluid sections, and the condensation surface can be positioned between the permeate section and the cold fluid section within the housing. The method can include providing a plurality of the membrane distillation modules, wherein for example the plurality of membrane distillation modules are staged in series.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts an example of temperature variation with depth of the sea^{[8].}

FIG. 2 depicts a membrane distillation (MD) process of the present disclosure.

FIG. 3 depicts a schematic diagram with operating conditions of an MD system of the present disclosure.

FIGS. 4(A) and 4(B) depict other types of membrane distillation modules that can be used in the present systems and methods: FIG. 4(A) depicts a vacuum membrane distillation (VMD) module; and FIG. 4(B) depicts a sweeping gas membrane distillation (SGMD) module.

FIG. 5 depicts an embodiment of a multi-stage system of the present disclosure.

FIG. 6 depicts experimental data obtained from a bench scale direct contact membrane distillation (DCMD) configuration showing that a membrane distillation (MD) process can be operated at very low temperature differences in the ranges described herein across the membrane.

### DETAILED DESCRIPTION

Described below are various embodiments of the present systems and methods for our systems and methods for desalinating water, in particular an ocean thermocline driven membrane distillation process. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art, Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DESCRIPTION

Membrane distillation (MD) can be cost effective technology for desalination with less chemical treatment than the conventional systems. The power consumption of MD plants are less compared to reverse osmosis (RO) processes, as they are operated in atmospheric conditions. MD can also make use of solar energy, geothermal energy and ocean thermal energy as the MD process requires only two streams with a difference in temperature. The dependence on fossil fuels and hence the associated harmful effects can be substantially reduced. MD plants have high flexibility in capacity as it can be assembled in modules. MD plants can be constructed from household units to plants in a few hundreds of MLD range. MD processes with their higher yield rate, lower size, lower construction cost, and low maintenance expenses can be competitive with other technologies.

In various aspects provided herein, for the first time, is a modified MD system and process for desalination of water, in particular seawater. The conventional process requires external heat energy to heat the feed solution or stream provided to the membrane. This can require solar collectors or other means to harvest the external heat energy to heat the feed stream. In contrast, in the present system and method an external heat source to heat the feed solution is not needed. In an aspect, the sensible heat available in surface seawater is used, and the surface seawater is used as the feed (warm) solution to the membrane. To provide the appropriate temperature gradient across the membrane, in an aspect, deep seawater is used as a cold/coolant solution to the permeate side of the membrane. The temperature gradient between these two seawater streams is enough to produce fresh water through the MD process. Thus, in an aspect, a system and process is provided using ocean temperature gradient difference (ocean thermocline) in membrane distillation for desalination of water, in particular seawater, and related applications. Furthermore, the modified MD system and process runs under lower temperatures compared to flash distillation which makes the thermocline difference in temperature (surface versus deep water temperatures) more suitable and more efficient with the MD process. Fouling and scaling problems can be much less using our systems and processes compared to the conventional systems.

In one or more aspects of the present disclosure, MD plants using ocean temperature (thermocline) difference can be established, for example for land based or floating MD plants or both. When deep seawater is available close to a land or an island with steep seabed, land based seawater desalination plants can be established close to the centers of water demand. Coastal regions and islands have normally high water demand. There are many potential locations in many countries. If deep sea cold water is not available within 5-10 km from the shore, floating plants can be set up and fresh water produced can be transported to the land.

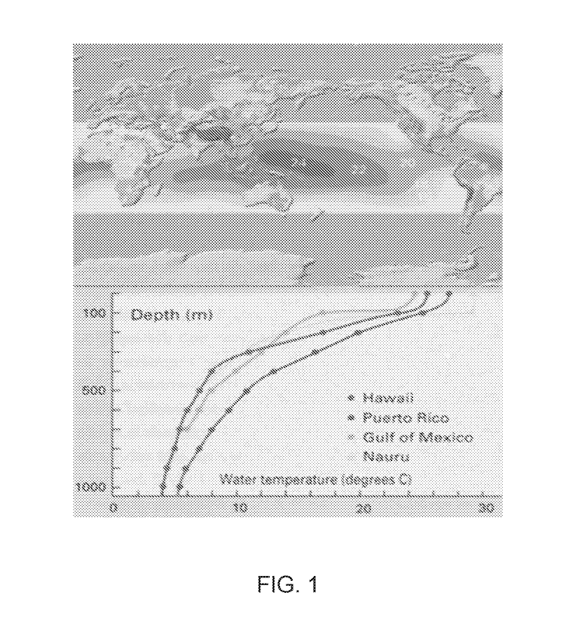

FIG. 1 shows the vertical ocean temperature distribution or gradient (thermocline) for a depth of 1,000 m at different parts of world. We have discovered that membrane distillation (MD) can be used for seawater desalination in a process utilizing the temperature gradient. In an embodiment, provided herein is a modified MD system and process using ocean temperature difference or gradient for desalination of water. It can make use of vapor pressure difference across a membrane for separation of non-volatile ions present in seawater to produce distilled water.

MD can be applied to different quality liquids with a temperature difference of 5° C. or above. It does not need high temperature heat source such as for Multi-stage flash (MSF) evaporators or high pressure pumps such as for reverse osmosis (RO) systems. MD can be assembled in modules. Hence there is flexibility in plant capacity. The initial investment and operating cost of desalination can be substantially reduced with MD technology.

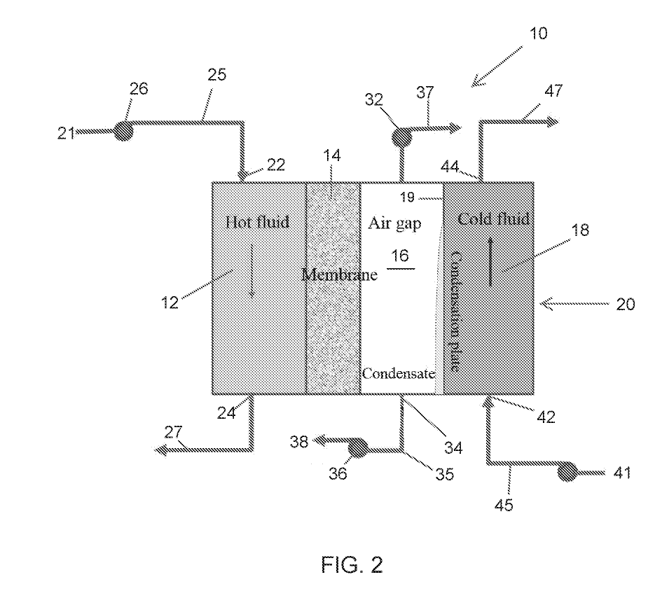

A simplified schematic of an embodiment of an MD system and process of the present disclosure is shown in FIG. 2. In an aspect, the MD system and process can be an air gap membrane distillation (AGMD) process or a vacuum controlled, or vacuum enhanced, air gap MD (VAGMD) process using surface and deep seawater. The system 10 can include a source 21 of warm seawater feed and a source 41 of cold seawater feed serving as a coolant. The various feed sources can be provided to MD module 20. In one or more aspects the source 21 of warm seawater feed can include a supply line 25 and a pump 26 to supply warm seawater to the MD module 20. The source of cold seawater 41 can include a supply line 45 and a pump 46 to supply cold seawater to the module 20.

Module 20 can include a housing or enclosure within which a warm or hot fluid section or compartment 12, a permeate condensate section or compartment 16 and a cold fluid section or compartment 18 are provided. A membrane 14 can be provided between the warm fluid section 12 and the permeate condensate section 16. The permeate condensate section 16 can be provided between the membrane 14 and the cold fluid section 18. In an aspect the permeate condensate section 16 can include an air gap, such as illustrated in FIG. 2. A condensation surface 19, such as a condensation plate, can be provided between the permeate condensate section 16 and the cold fluid section 18. The condensation surface 19 can also serve to isolate the coolant (in the form of relatively colder seawater than the warm seawater feed) from the permeate so that salt in the coolant does not contaminate the desalinated permeate.

In an aspect the membrane 14 is comprised of a material that permits water vapor to pass there through but not water. The membrane can be a porous hydrophobic material, for example a microporous hydrophobic material. The membrane can be made of a polymeric material. For example, the membrane can be made of polyvinylidine fluoride (PVDF), polytetrafluoroethylene (PTFE), polyethylene (PE), polypropylene (PP), polyazoles, fluorinated poly azoles, and their nanocomposite membranes and surface modified membrane, hydrophobically modified ceramic membranes, multilayer membranes including hydrophilic-hydrophobic combinations. The membrane can be either a hollow fiber membrane, a tubular membrane or a flat sheet membrane. Suitable flat sheet membranes can be made either by phase inversion technique or by electrospinning technique. Hollow fiber membranes can be fabricated either via non solvent induced phase separation (NIPS) or by thermally induced phase separation (TIPS). Examples of suitable membranes are disclosed in our co-pending U.S. Application No. 62/095,136, filed Dec. 22, 2014 which is incorporated by reference as if fully set forth herein.

Module 20 can include a warm fluid inlet 22 for providing warm or hot fluid (e.g. warm seawater) from supply line 25 to the warm fluid section 12. The warm fluid section 12 can also include an outlet 24 for passing fluid (e.g., concentrated seawater) out of the warm fluid section 12 and out of module 20. Module 20 can also include an inlet for providing cold fluid or coolant (e.g., cold seawater) into the cold fluid section 18 within module 20 via supply line 45. The cold fluid section 18 can also have an outlet 44 for passing fluid out of the cold fluid section 18 via outlet line 47.

When the warm seawater passes by the membrane 14, due to a partial pressure difference across it as a result of the temperature difference created by flowing a coolant (in the form of the cold fluid) on the other side of the membrane, water vapor is generated from the warm seawater feed and passes (permeates) through the membrane 14, This vapor, also referred to as permeate, will condense within the air gap within the permeate condensate section 16 when it comes into contact with the condensing surface 19 (e.g., a condensation plate). In an embodiment, the permeate condensate section or air gap 16 does not have an external influence such as either negative pressure (vacuum) or positive pressure (such as a sweeping gas) applied to it.

In an embodiment, vacuum (negative pressure) can optionally be maintained in the air gap 16 between the membrane 14 and the condensation surface 19 by vacuum pump 32 drawing air 37 out of air gap 16 providing what is sometimes referred to as vacuum enhanced air gap membrane distillation (VAGMD). Alternately, positive air pressure can be applied to the air gap 16. Condensed permeate, or condensate, 38 can be withdrawn (e.g., pumped out via pump 36) and can be used for fresh water requirements, or any other purpose alter suitable re-mineralization, More details of the MD process, per se, are reported in literature^{[9-11].} Surface seawater temperature can be further enhanced using solar thermal panels (not shown). This can be used to increase the temperature gradient and hence production and efficiency of the system. Solar thermal panels can also provide the energy to run the system and makes the process autonomous.

The membrane 14 can also be called an evaporator. One or more membranes 14 or evaporators can be included. One or more condensers or condensing surfaces 19 can also be included. In an aspect, the condenser(s) or condensing surfaces 19 can be formed of dense polymeric or non-corrosive hollow fibers or flat sheets.

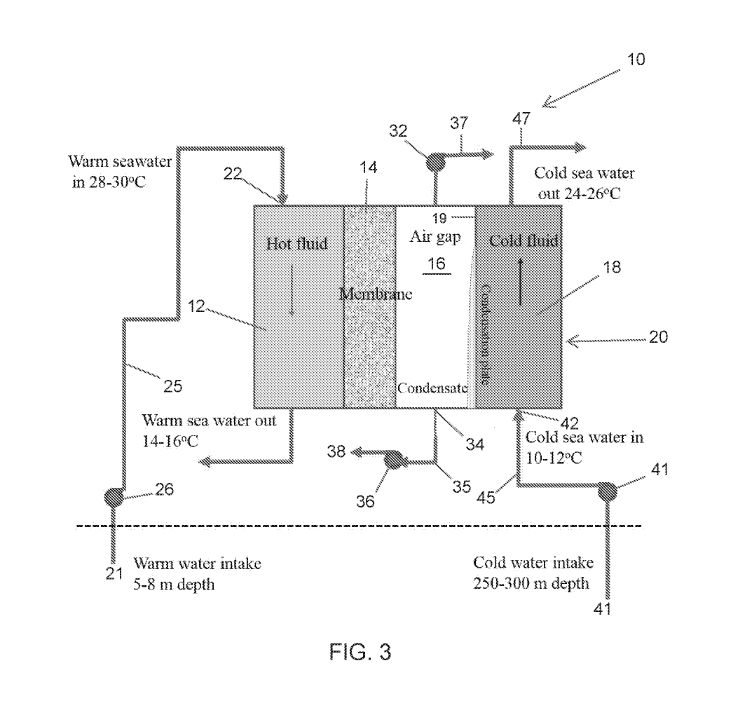

Many parts of the world have a temperature difference of 15° C. or more between surface seawater and seawater from 250-300 m depth, that are ideal for use in the present systems and methods. Most of the islands in the ocean have a steep temperature profile between the surface water and the ocean floor. A land based plant can draw deep sea water with a pipe line laid with additional anchor weights attached. FIG. 3 shows operating conditions and process details for a typical sea condition for an MD plant utilizing thermocline of the present disclosure. Surface seawater temperature can vary by 2-3° C. due to seasonal variations.

As depicted in FIG. 3, the warm seawater feed can have a temperature in the range of 28-30° C. and the cold seawater feed has a temperature in the range of 10-12° C., thus providing a temperature differential between the inlet feeds of approximately 18-20° C. between the warm seawater feed and the cold seawater feed. The temperature of the warm seawater feed passed out of the warm fluid section 12 can be in the range of 14-16° C. The temperature of the cold seawater feed passed out of the cold fluid section 18 can be in the range of 24-26° C., providing a temperature difference between the outlet feeds of about 10-12° C.

The temperatures of the warm and cold seawater feeds do not have to be exactly these temperatures. For example, there are locations in the Red Sea having a temperature difference of 15-17° C. for which the present systems and methods can be used. Cold water at 17-18° C. is available at a depth of 120-150 rte depth and surface seawater at 32-35° C., as reported by Sofianos and Johns^{[12].} This region is close to many inhabited islands. There is the potential for supplying drinking water to the community living there by installing one or more MD plants of the present disclosure.

While specific temperatures and temperature ranges are provided and discussed in relation to FIG. 3, one skilled in the art will recognize that other temperatures and temperature ranges are possible. For example in one or more aspects, the warm water feed inlet can be drawn from surface seawater and can have a temperature of about 23° C. to about 35° C. or any variation there between, and in other aspects in the range of about 23° C. to 30° C., or 28° C. to 30° C. or any variation therebetween. In some aspects, drawn cold water feed inlet temperature can be in the range of about 4° C. to about 18° C. and any variation there between. In various other aspects, the drawn cold water inlet temperature can be in the range of about 4° C. to about 16° C. and any variation there between, for example, about 10° C. to about 12′C, or about 17° C. to 18° C. and any variation therebetween. In various aspects the temperature difference between the warm water inlet temperature and the cold water inlet temperature can be 5° C. or more. For example the temperature difference between the warm water and the cold water inlet feeds can be in the range of 7° C. to 26° C., 10° C. to 20° C., 16° C. to 20° C., 18° C. to 20° C. or 15° C. to 17° C., or any variation there between.

In other aspects, the warm and cold feeds can come from other sources. For example the warm feed can be provided from hot water discharge from thermal power plants. Such water can have a temperature of about 5° C. to about 10° C. greater than seawater temperature. If desired the warm water feed can be coupled with low pressure steam to provide a desired temperature difference between the warm water and cold water feeds, for example a difference about 10° C. to 20° C. In other aspects, the warm water feed can be provided from warm water having waste heat from a ship engine. Such warm water feed have a temperature of about 60′C to about 80° C. In other aspects, the temperature difference across the membrane can be at least 5′C or greater. In other aspects where needed, the heat in the warm water feed can be supplemented or increased by external heating, such as by solar heat to provide a desired temperature differential between the warm and cold water feeds and cross the membrane.

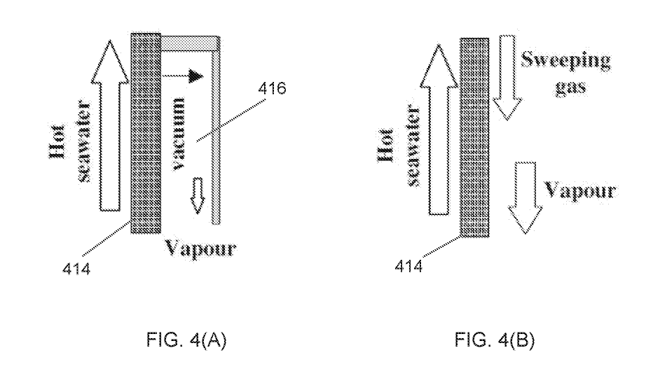

While FIG. 2 depicts an embodiment of an MD module configuration for use in the present system, it is also possible to integrate some other MD modules in the system, such as: a vacuum membrane distillation (VMD) module, FIG. 4(A); and/or a sweeping gas membrane distillation (SGMD) module, FIG. 4(B), to operate the process. In the VMD configuration, vacuum (negative pressure) is maintained in the air gap 416 between the membrane (evaporator) 414 and condenser. In the SGMD process an inert gas is utilized in and swept through (with positive pressure) the space or air gap along the permeate side of the membrane 414 to enhance the permeation and condensation process.

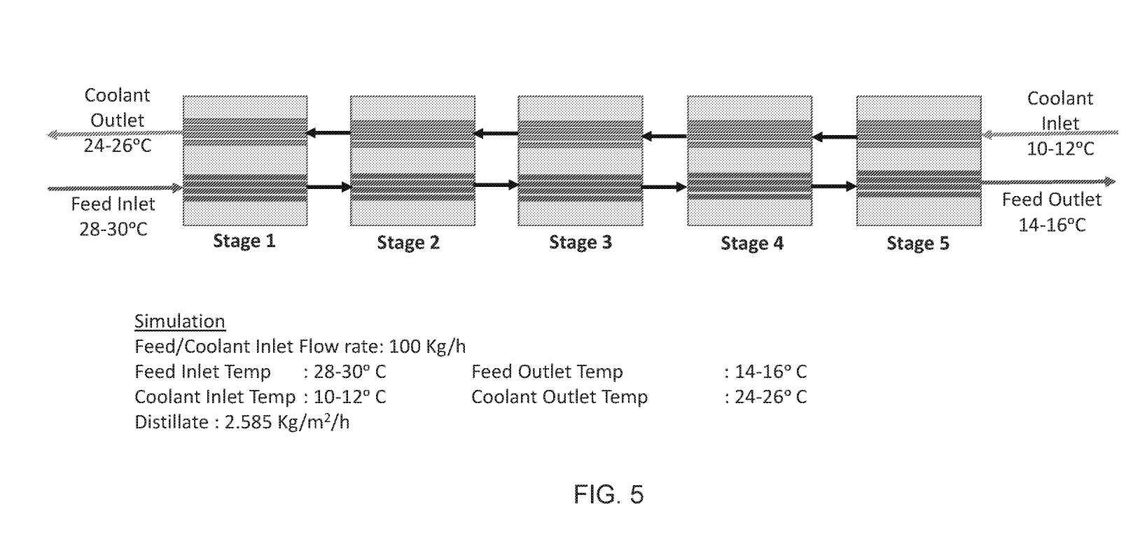

It is also possible to integrate additional MD modules into the system. The system can include a plurality of stages of membrane distillation modules, such as a plurality of the modules depicted in FIG. 2. In such aspects, the modules can be staged, for example disposed in series as depicted in FIG. 5. FIG. 5 provides a depiction of a schematic of MD staging at very low feed/coolant temperatures. While the schematic of FIG. 5 illustrates 5 stages, each stage constituting a module such as that depicted in FIG. 2, one skilled in the art ill recognize, however, that more stages or fewer stages may be employed depending upon the circumstances. The exemplary data provided in FIG. 5 are simulated data and results for a five staged vacuum enhanced AGMD process. Further examples of such systems are depicted and described in co-pending U.S. Application No. 62/095,135, filed Dec. 22, 2014, which is incorporated by reference as if fully described herein.

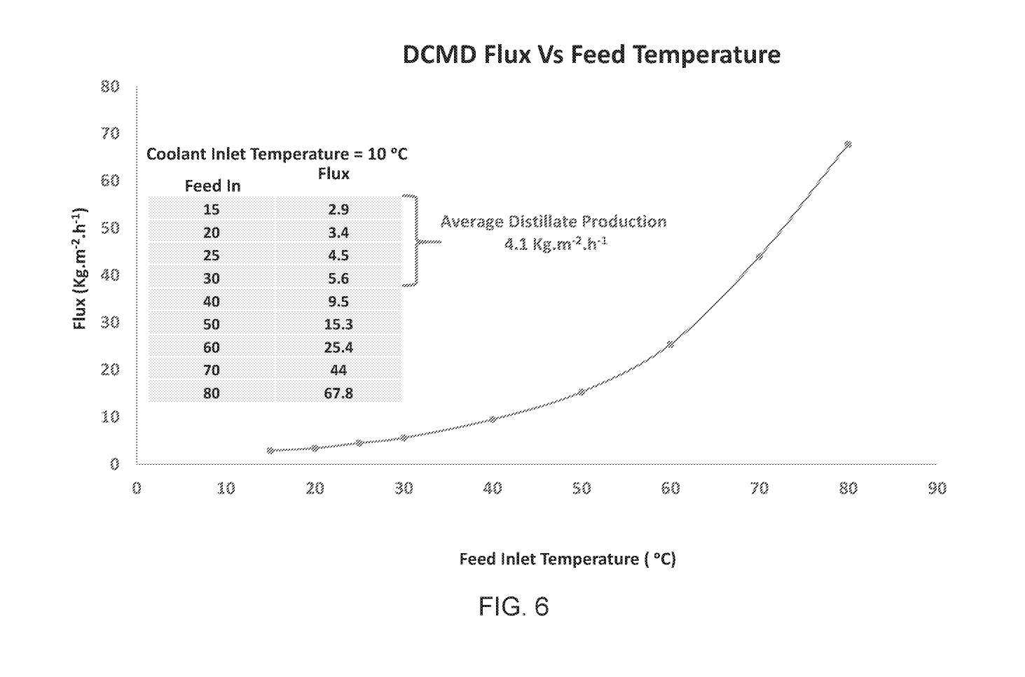

FIG. 6 depicts experimental data obtained from a bench scale direct contact membrane distillation (DCMD) configuration showing that an MD process can be operated at the very low differences in the ranges described herein across the membrane. Average distillate production during the DCMD configuration of FIG. 6 and the VAGMD configuration of FIG. 5 were 4.1 LMH and 2.58 LMH, respectively.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

### REFERENCES

1. Elimelech, M.; Phillip, W. A., Science, 2011, 333, 712-717.
2. Shannon, M. A.; Bohn, P. W.; Elimelech, M.; Georgiadis, J. G.; Marinas, B. J.; Mayes, A. M., Nature, 2008, 452, 301-309.
3. Ghaffour, N.; Missirner, T. M.; Amy, G. L., Desalination, 2013, 309, 197-207.
4. Fiorenza, G.; Sharma, V. K.; Braccio, G., Energy Conversion and Management, 2003, 44, 2217-2240,
5. Khayet, M.; Matsuura, T. Membrane distillation: principles and applications; Elsevier: Amsterdam, The Netherlands, 2011.
6. Al-Obaidani, S.; Curcio, E.; Macedonio, F.; Profio, G. D.; Al-Hindai, H.; Drioli, E., J. Membr. Sci., 2008, 323, 85-98.
7. Hanemaaijer, J. H.; van Medevoort, J.; Jansen, A. E.; Dotremont, C.; van Sonsbeek, E.; Yuan, T.; Ryck, L. D., Desalination, 2006, 199, 175-176.
8. http://www.joes.saga-u.ac.jp/english/about_oetc.html
9. L. Francis; N. Ghaffour; A. S. Alsaadi; S.F. Nunes; G. Amy; Performance evaluation of DCMD desalination process under bench scale and large scale module operating conditions, J. Membr. Sci. 455 (2014) 103-112.
10. A. S. Alsaadi, N. Ghaffour, J. D. Li, S. Gray, L. Francis, H. Maab, G. L. Amy, Modeling of air-gap membrane distillation process: A theoretical and experimental study, J. Membr, Sci, 445 (2013) 53-65.
11. L. Camacho, L. Dume'e, J, Zhang, J.-D. Li, M. Duke, J. Gomez, S. Gray, Advances in membrane distillation for water desalination and purification applications, Water 5 (2013) 94-196.
12. S. S. Sofianos, & W. E. Johns., Observations of the summer Red Sea circulation. Journal of Geophysical Research: Oceans, 1978-2012 (2007)112(C6).
13. Panchal, C. B., and K. J. Bell, Simultaneous production of desalinated water and power using a hybrid-cycle OTEC plant, Journal of solar energy engineering 109.2 (1987) 156-160.
14. Abdel-Aal, H. K., et al., Sea thermal power: a survey study for the Arab coastal waters, Energy Sources 12.4 (1990) 393-405.
15. Abraham, R., Robert Singh T. and Rajkumar N., Low Temperature Thermal Desalination using ocean temperature difference, International Conference on Coastal and Ocean Technology, 10-12 Dec. 2003, National Institute of Ocean Technology, Chennai.
16, Muthunayagam, A. E., K. Ramamurthi, and J. R. Paden, Low temperature flash vaporization for desalination, Desalination, 180, 1 (2005) 25-32,
17. Abraham, R. and Robert Singh, Thermo-cline Driven Desalination—The technology and potential, International J. Nuclear Desalination 2, 2(2006) 109-116.
18. Abraham, R., Experimental studies on desalination plant utilizing ocean temperature difference, International J. Nuclear Desalination 2, 4 (2007) 383-392.
19. Paden, J. Justin Robert, P. K. Tewari, D. Venkatram, and D. Barnabas. Spray flash evaporator for low-temperature saline water desalination application, International Journal of Nuclear Desalination 2, 4 (2007) 393-405.
20. Mutair, S. and Ikegami, Y, Study and Enhancement of Flash Evaporation Desalination Utilizing the Ocean Thermo-cline and Discharged heat, Proceedings of World Academy of Science: Engineering & Technology (2008) 45.
21. A Process, System and Configuration for Desalination of Sea water: Indian Patent 196396 of 21 02 2003 by Dr. A. E. Muthunayagam

1. A method for membrane distillation of seawater, comprising the steps of:
a) providing a membrane distillation module including a housing, a warm fluid section, a cold fluid section, a permeate section, a membrane positioned between the warm fluid section and the permeate section, at least a portion of the membrane being adjacent to and in communication with at least a portion of the warm fluid section and a condensation surface positioned in association with the permeate section and the cold fluid section,
wherein the warm fluid section and the cold fluid section each include a fluid inlet through which fluid can be delivered into each of the warm fluid and cold fluid sections and a fluid outlet through which fluid can flow out of each of the warm fluid and cold fluid sections, and
wherein the permeate section includes an outlet through which permeate can flow out of the permeate section, and
wherein the membrane is comprised of a material that permits water vapor to pass there through but not water;
b) passing warm fluid through the warm fluid section, the warm fluid being warm seawater;
c) passing cold fluid through the cold fluid section, the cold fluid being seawater that is relatively colder than the warm fluid, thereby creating a temperature difference between the warm fluid and the cold fluid; and
d) passing permeate from the warm fluid section through the membrane into the permeate section, by utilizing a vapor pressure difference across the membrane due to the temperature difference between the warm fluid and the cold fluid streams, the permeate being in the form of water vapor.

2. The method of claim 1, wherein the warm fluid has a temperature in the range of 23° C.-35° C., preferably 23° C.-30° C.

3. The method of claim 1, wherein the warm fluid is taken directly from the sea or ocean from a depth of 5-8 meters below the surface of the sea or ocean without heating or cooling and utilizing its own sensible heat by passing the warm fluid into the warm fluid section of the membrane distillation module.

4. The method of claim 1, wherein the cold fluid is in the form of cold seawater.

5. The method of claim 4, wherein the cold seawater has a temperature in the range of 4° C.-18° C., preferably 4° C.-16° C.

6. The method of claim 4, wherein the cold seawater is taken directly from the sea or ocean from a depth of 250-300 m below the surface of the sea or ocean.

7. The method of claim 4, wherein the cold seawater is passed directly into the cold fluid section of the membrane distillation module without heating or cooling the cold seawater.

8. The method of claim 1, wherein the temperature of the warm fluid passed into the warm fluid section is in the range of 28-30° C. and the temperature of the warm fluid passed out of the warm fluid section is in the range of 14-16° C.

9. The method of claim 1, wherein the temperature difference between the warm fluid passed into the warm fluid section and the cold fluid passed into of the cold fluid section is at least 5° C., and preferably in the range of 7° C.-26° C.

10. The method of claim 1, wherein the temperature of the cold fluid passed into the cold fluid section is in the range of 10-12° C. and the temperature of the cold fluid passed out of the cold fluid section is in the range of 24-26° C.

11. The method of claim 1, including the step of:
wherein the condensation surface is in thermal association with the cold fluid and the method includes; e) passing the permeate in the permeate section into thermal contact with the condensation surface and condensing the permeate.

12. The method of claim 1, wherein the warm fluid is obtained from surface seawater, hot water discharge from a water plant, from waste heat from a ship engine or any combination thereof.

13. The method of claim 1, wherein the condensation surface isolates cold fluid provided in the cold fluid section from permeate that may collect in the permeate section.

14. The method of claim 1, wherein the membrane distillation module is selected from the group consisting of an air gap membrane distillation (AGMD) module, a vacuum enhanced air gap membrane distillation (VAGMD) module, a vacuum membrane distillation (VMD) module, and a sweeping gas membrane distillation (SGMD) module.

15. The method of claim 1, wherein a plurality of modules are staged in series.
